(19) United States
(12) Patent Application Publication
(10) Pub. No.: US 2011/0191358 A1
(43) Pub. Date: Aug. 4, 2011

(54) FILE FORMAT CONVERSION SYSTEM AND METHOD THEREOF

(76) Inventors: Kuan-Lin Kuo, Kaohsiung City (TW); Li-Jen Chao, Taipei County (TW); Din-Ji Tzou, Taipei City (TW); Chih-Heng Chiu, Taipei City (TW); Chung-Won Shu, Taipei City (TW)

(21) Appl. No.: 12/696,063

(22) Filed: Jan. 29, 2010

(51) Int. Cl. G06F 15/16; G06F 17/30

(52) U.S. Cl. 707/756; 709/246; 707/E17.006

(57) ABSTRACT

A file format conversion system includes a web server, a service providing server and an electronic device. The web server provides a first URL associated with a first file. The electronic device sends a request of the first URL to the service providing server. The service providing server analyzes the first URL based on the request and generates a first list, which records file formats stored at the first URL. The electronic device separates the first list into a second list, which records file formats supported by the electronic device, and a third list, which records file formats not supported by the electronic device. After receiving the second and third list, the service providing server updates two databases inside. The service providing server converts the first file into a second file based on the second and third lists and generates a second URL associated with the second file.

### BACKGROUND OF THE INVENTION

1. Field of the Invention

The invention relates to a file format conversion system and method thereof and, more particularly, to a file format conversion system and method thereof capable of automatically and dynamically converting file formats for an electronic device even though device information of the electronic device is unknown.

2. Description of the Prior Art

As technology advances, various electronic devices including personal digital assistant (PDA), mobile phone, digital photo frame, and so on are capable of browsing multimedia files, such as video, audio, text, or image files stored at a Uniform Resource Locator (URL) through Internet. These multimedia files usually have more than one file format. For example, video files may be formatted as WMV, AVI, MPEG (e.g. MPEG-1, MPEG-2, MPEG-4, MPEG-7, and MJPEG), DivX, Apple QuickTime, etc., and image files may be formatted as GIF, JPEG, BMP, TIFF, FlashPix, etc. Unfortunately, most of the electronic devices have limited computing capability due to light weight and small size, so not all of the file formats can be supported by each electronic device. If a user uses an electronic device to browse a URL associated with a JPEG image file and the electronic device only supports a GIF image file, the JPEG image file will not be shown.

Therefore, some prior arts have been developed to convert file format automatically while the file format is not supported by the electronic device. However, in these prior arts, it is necessary to install a database with device information in advance. If the device information of one specific electronic device does not be stored in the database, the prior arts cannot recognize the electronic device and cannot know which file format can or cannot be supported by the electronic device. Consequently, some multimedia files not supported by the electronic device still will not be shown. It is very inconvenient for the user.

### SUMMARY OF THE INVENTION

An objective of the invention is to provide a file format conversion system and method thereof capable of automatically and dynamically converting file formats for an electronic device even though device information of the electronic device is unknown.

According to one embodiment, a file format conversion system of the invention comprises a web server, a service providing server and an electronic device. The web server provides a first Uniform Resource Locator (URL) associated with a first file. The electronic device sends a request of the first URL to the service providing server. The service providing server analyzes the first URL from the web server based on the request, generates a first list, which records file formats stored at the first URL, and sends the first list to the electronic device. The electronic device separates the first list into a second list, which records file formats supported by the electronic device, and a third list, which records file formats not supported by the electronic device, and sends the second and third lists to the service providing server. After receiving the second and third lists, the service providing server updates two databases inside. The service providing server converts the first file, which is formatted as one of the file formats recorded in the third list, into a second file, which is formatted as one of the file formats recorded in the second list, generates a second URL associated with the second file, and sends the second URL to the electronic device. Accordingly, the second URL associated with the second file can be browsed on the electronic device.

According to another embodiment, a file format conversion method of the invention comprises steps of: receiving a request of a first URL from an electronic device, wherein the first URL is associated with a first file; analyzing the first URL based on the request; generating a first list, which records file formats stored at the first URL; sending the first list to the electronic device; receiving a second list, which records file formats supported by the electronic device, and a third list, which records file formats not supported by the electronic device, from the electronic device, wherein the second and third lists are generated by the electronic device based on the first list; converting the first file, which is formatted as one of the file formats recorded in the third list, into a second file, which is formatted as one of the file formats recorded in the second list; generating a second URL associated with the second file; and sending the second URL to the electronic device. Accordingly, the second URL associated with the second file can be browsed on the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a file format conversion system according to one embodiment of the invention.

FIG. 2 is a schematic diagram illustrating the first database shown in FIG. 1.

FIG. 3 is a flow chart of a file format conversion method according to one embodiment of the invention.

FIG. 4 is a flow chart of a file format conversion method according to another embodiment of the invention.

### DETAILED DESCRIPTION

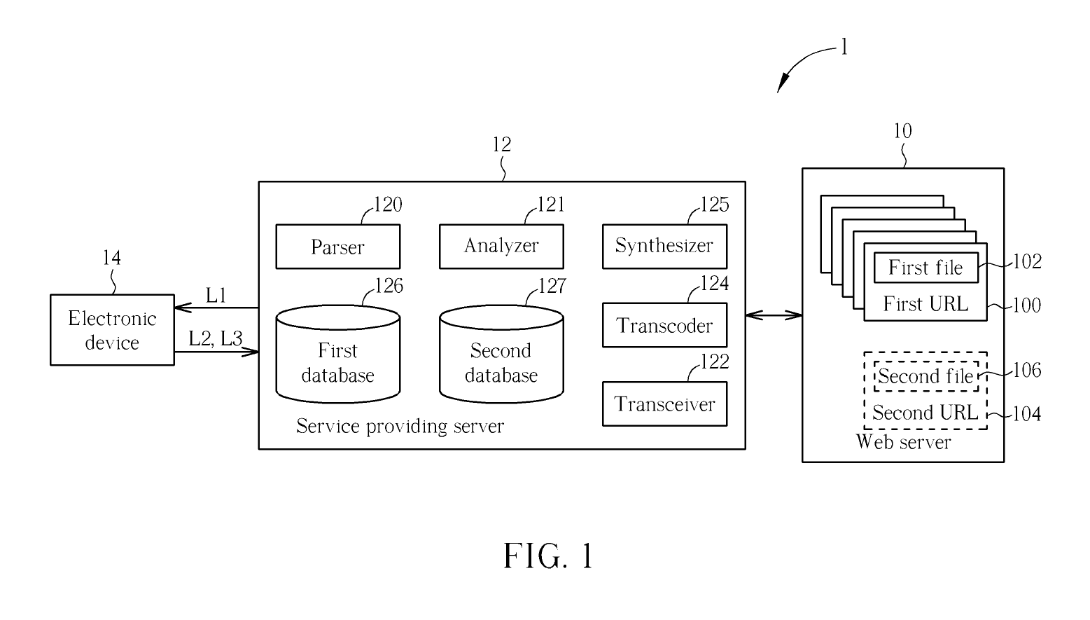

Referring to FIG. 1, FIG. 1 is a functional block diagram illustrating a file format conversion system 1 according to one embodiment of the invention. As shown in FIG. 1, the file format conversion system 1 comprises a web server 10, a service providing server 12 and an electronic device 14. The web server 10, the service providing server 12 and the electronic device 14 communicates with each other through network such as Internet. The service providing server 12 comprises a parser 120, an analyzer 121, a transceiver 122, a transcoder 124, a synthesizer 125, a first database 126 and a second database 127. In this embodiment, the web server 10 may provides a plurality of URLs including a first URL 100 associated with a first file 102, and the electronic device 14 may be PDA, mobile phone, digital photo frame and so on. In this embodiment, the first file 102 is formatted as one file format not supported by the electronic device 14.

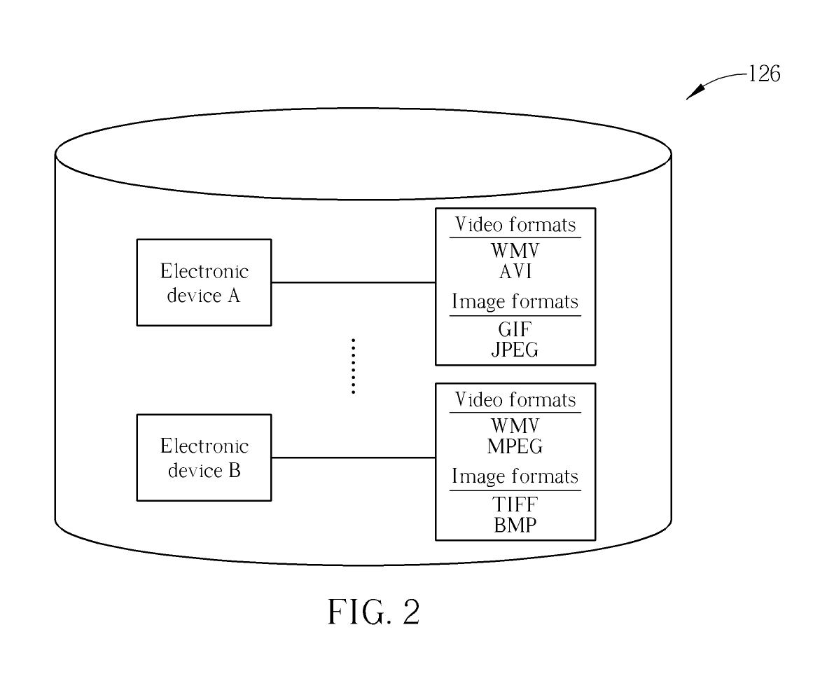

Referring to FIG. 2, FIG. 2 is a schematic diagram illustrating the first database 126 shown in FIG. 1. The first database 126 is used for storing file format lists associated with different electronic devices. For example, the first database 126 may store a file format list, which records video formats including WMV and AVI and image formats including GIF and JPEG, associated with an electronic device A, and may store another file format list, which records video formats including WMV and MPEG and image formats including TIFF and BMP, associated with another electronic device B, as shown in FIG. 2. The second database 127 is used for recording a browsing history of the electronic device 14.

If a user wants to utilize the electronic device 14 to browse the first URL 100, he or she has to operate the electronic device 14 to send a request of the first URL 100 to the service providing server 12. It should be noted that when sending the request, the electronic device 14 may further send device information thereof to the service providing server 12. When the parser 120 receives the request of the first URL 100 and the device information from the electronic device 14, the service providing server 12 will look the device information up in the first database 126 to determine whether file formats supported by the electronic device 14 have been stored, and the analyzer 121 will analyze the first URL 100 from the web server 10 based on the request and generate a first list L1, which records file formats stored at the first URL 100.

If the file formats supported by the electronic device 14 have been stored in the first database 126, the transcoder 124 will convert the first file 102 into a second file 106, which is formatted as one of the file formats recorded in the first database 126 and supported by the electronic device 14. For example, if the first file 102 is an MPEG file and the file formats supported by the electronic device 14 and stored in the first database 126 are WMV and AVI, the transcoder 124 may convert the first file 102 into the second file 106, which is formatted as WMV. Afterward, the synthesizer 125 will generate a second URL 104 associated with the second file 106 and send the second URL 104 to the electronic device 14 via the transceiver 122. Consequently, the user can utilize the electronic device 14 to browse the second URL 104 with the second file 106.

On the other hand, if the file formats supported by the electronic device 14 does not be stored in the first database 126 yet, after analyzing the first URL 100 from the web server 10 based on the request and generating the first list L1, which records file formats stored at the first URL 100, the service providing server 12 will sends the first list L1 to the electronic device 14 via the transceiver 122. After receiving the first list L1, the electronic device 14 separates the first list L1 into a second list L2, which records file formats supported by the electronic device 14, and a third list L3, which records file formats not supported by the electronic device 14, and sends the second and third lists L2 and L3 to the service providing server 12. For example, if the first list L1 records file formats as WMV, AVI and MPEG and the file formats supported by the electronic device 14 is WMV and AVI, the second list L2 records the file formats as WMV and AVI and the third list L3 records the file format as MPEG.

After receiving the second and third lists L2 and L3 via the transceiver 122, the transcoder 124 will convert the first file 102, which is formatted as one of the file formats (e.g. MPEG) recorded in the third list L3, into the second file 106, which is formatted as one of the file formats (e.g. WMV) recorded in the second list L2. Afterward, the synthesizer 125 will generate a second URL 104 associated with the second file 106 and send the second URL 104 to the electronic device 14 via the transceiver 122. Consequently, the user can utilize the electronic device 14 to browse the second URL 104 with the second file 106.

Furthermore, the service providing server 12 will update the first database 126 with the second list L2. If a user utilizes another electronic device (not shown) with the same device information as the electronic device 14 to browse the first URL 100, the transcoder 124 can convert the first file 102 into the second file 106 based on the file formats recorded in the first database 126 directly.

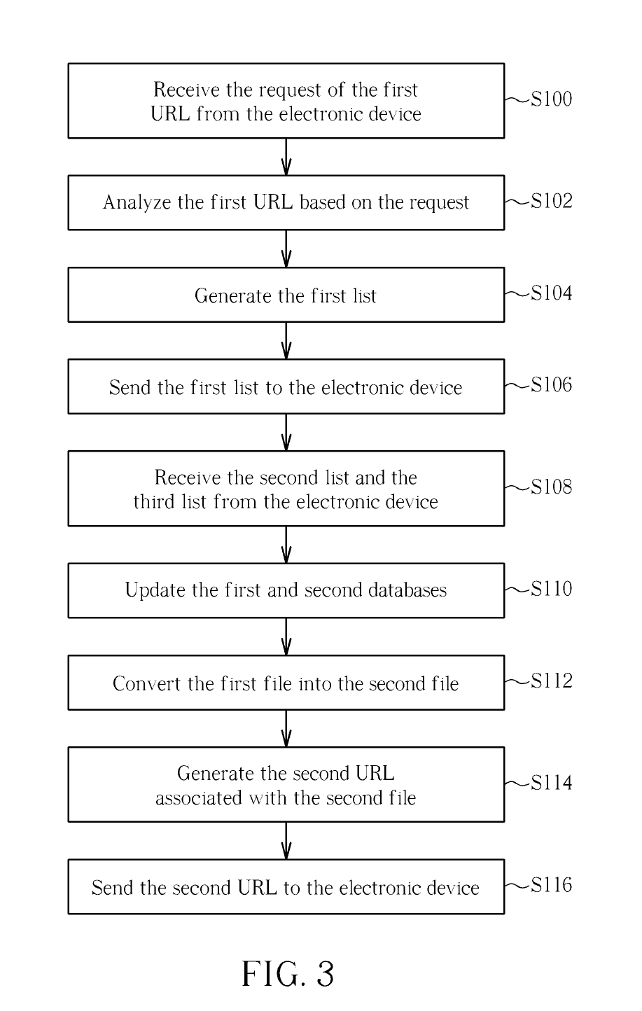

Referring to FIG. 3, FIG. 3 is a flow chart of a file format conversion method according to one embodiment of the invention. As shown in FIGS. 1 and 3 along with the aforesaid file format conversion system 1, a file format conversion method comprises the following steps. In the beginning, step S100 is performed to receive the request of the first URL 100 from the electronic device 14. Afterward, step S102 is performed to analyze the first URL 100 based on the request. Step S104 is then performed to generate the first list L1. Step S106 is then performed to send the first list L1 to the electronic device 14. Step S108 is then performed to receive the second list L2 and the third list L3 from the electronic device 14, wherein the second and third lists L2 and L3 are generated by the electronic device 14 based on the first list L1. Step S110 is then performed to update the first database 126 and the second database 127. Step S112 is then performed to convert the first file 102 into the second file 106. Step S114 is then performed to generate the second URL 104 associated with the second file 106. Finally, step S116 is performed to send the second URL 104 to the electronic device 14. It should be noted that the principle of the aforesaid components is mentioned in the above, so it will not be depicted herein.

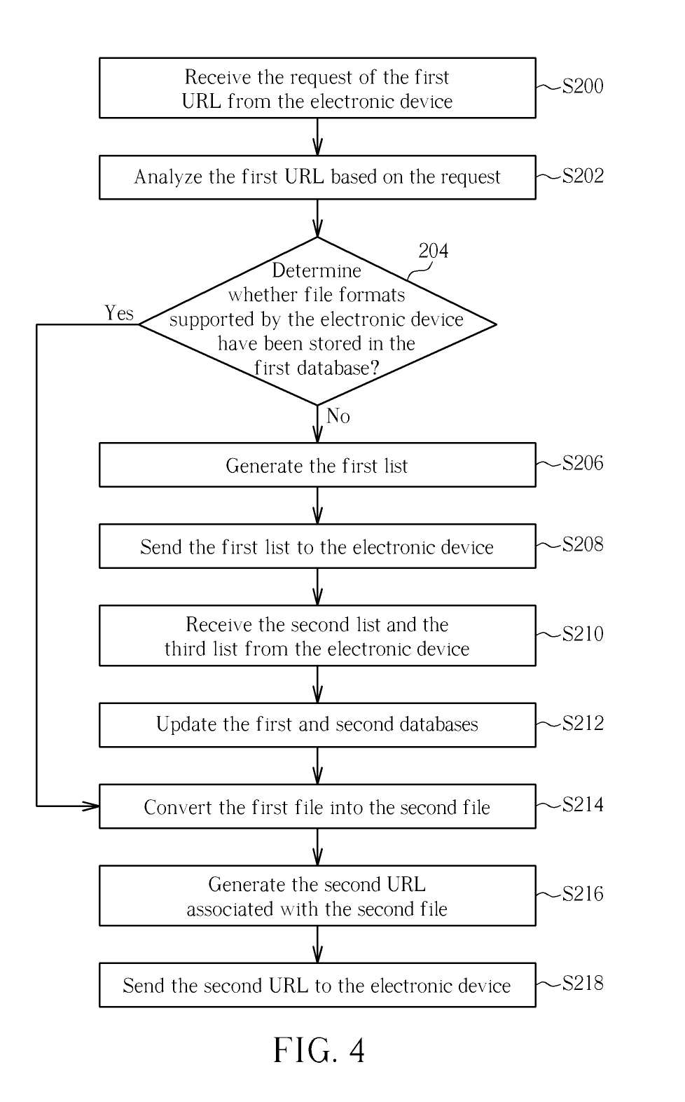

Referring to FIG. 4, FIG. 4 is a flow chart of a file format conversion method according to another embodiment of the invention. As shown in FIGS. 1 and 4 along with the aforesaid file format conversion system 1, a file format conversion method comprises the following steps. In the beginning, step S200 is performed to receive the request of the first URL 100 and the device information from the electronic device 14. Afterward, step S202 is performed to analyze the first URL 100 based on the request. Step S204 is then performed to determine whether file formats supported by the electronic device 14 have been stored in the first database 126. If it is YES in step S204, step S214 is then performed, otherwise step S206 is performed. Step S206 is then performed to generate the first list L1. Step S208 is then performed to send the first list L1 to the electronic device 14. Step S210 is then performed to receive the second list L2 and the third list L3 from the electronic device 14, wherein the second and third lists L2 and L3 are generated by the electronic device 14 based on the first list L1. Step S212 is then performed to update the first database 126 and the second database 127. Step S214 is then performed to convert the first file 102 into the second file 106. Step S216 is then performed to generate the second URL 104 associated with the second file 106. Finally, step S218 is performed to send the second URL 104 to the electronic device 14. It should be noted that the principle of the aforesaid components is mentioned in the above, so it will not be depicted herein.

Compared to the prior art, the invention is capable of auto-learning. That is, since the electronic device can actively separate the first list, which is generated by the service providing server based on the file formats stored at the requested URL, into the second and third lists and send the two lists to the service providing server for purpose of file format conversion, the invention is capable of automatically and dynamically converting file formats for the electronic device even though device information of the electronic device is unknown.

Those skilled in the art will readily observe that numerous modifications and alterations of the device and method may be made while retaining the teachings of the invention.

What is claimed is:

1. A file format conversion system comprising:
a web server providing a first Uniform Resource Locator (URL) associated with a first file;
a service providing server; and
an electronic device sending a request of the first URL to the service providing server;
wherein the service providing server analyzes the first URL from the web server based on the request, generates a first list, which records file formats stored at the first URL, and sends the first list to the electronic device;
wherein the electronic device separates the first list into a second list, which records file formats supported by the electronic device, and a third list, which records file formats not supported by the electronic device, and sends the second and third lists to the service providing server; and
wherein the service providing server converts the first file, which is formatted as one of the file formats recorded in the third list, into a second file, which is formatted as one of the file formats recorded in the second list, generates a second URL associated with the second file, and sends the second URL to the electronic device.

2. The file format conversion system of claim 1, wherein the service providing server comprising a first database for storing the second list associated with the electronic device.

3. The file format conversion system of claim 1, wherein the service providing server comprising a second database for recording a browsing history of the electronic device.

4. The file format conversion system of claim 1, wherein the service providing server comprising:
a parser for receiving the request of the first URL from the electronic device;
an analyzer for analyzing the first URL from the web server based on the request and generating the first list;
a transceiver for sending the first list and the second URL to the electronic device and receiving the second and third lists from the electronic device;
a transcoder for converting the first file into the second file; and
a synthesizer for generating the second URL associated with the second file.

5. A file format conversion method comprising steps of:
receiving a request of a first Uniform Resource Locator (URL) from an electronic device, wherein the first URL is associated with a first file;
analyzing the first URL based on the request;
generating a first list, which records file formats stored at the first URL;
sending the first list to the electronic device;
receiving a second list, which records file formats supported by the electronic device, and a third list, which records file formats not supported by the electronic device, from the electronic device, wherein the second and third lists are generated by the electronic device based on the first list;
converting the first file, which is formatted as one of the file formats recorded in the third list, into a second file, which is formatted as one of the file formats recorded in the second list;
generating a second URL associated with the second file; and
sending the second URL to the electronic device.

6. The file format conversion method of claim 5, comprising step of updating a first database with the second list associated with the electronic device.

7. The file format conversion method of claim 5, comprising step of recording a browsing history of the electronic device.

8. An electronic device capable of communicating with a web server and a service providing server, the web server providing a first Uniform Resource Locator (URL) associated with a first file, when the electronic device sends a request of the first URL to the service providing server, the service providing server analyzing the first URL from the web server based on the request, generating a first list, which records file formats stored at the first URL, and sending the first list to the electronic device; after receiving the first list, the electronic device separating the first list into a second list, which records file formats supported by the electronic device, and a third list, which records file formats not supported by the electronic device, and sending the second and third lists to the service providing server; after receiving the second and third lists, the service providing server converting the first file, which is formatted as one of the file formats recorded in the third list, into a second file, which is formatted as one of the file formats recorded in the second list, generating a second URL associated with the second file, and sending the second URL to the electronic device.

9. The electronic device of claim 8, wherein the second list associated with the electronic device is updated in a first database of the service providing server.

10. The electronic device of claim 8, wherein a browsing history of the electronic device is updated in a second database of the service providing server.
